(19) United States
(12) Patent Application Publication
(10) Pub. No.: US 2026/0348473 A1
(43) Pub. Date: Nov. 5, 2026

(54) MECHANICAL SEAL ARRANGEMENT

(71) Applicant: EagleBurgmann Germany GmbH & Co. KG, Wolfratshausen (DE)

(72) Inventor: Felix Meier, Taufkirchen (DE)

(73) Assignee: EagleBurgmann Germany GmbH & Co. KG, Wolfratshausen (DE)

(21) Appl. No.: 19/100,027

(22) PCT Filed: Jun. 1, 2023
(86) PCT No.: PCT/EP2023/064645

§ 371 Date: Jan. 30, 2025

(30) Foreign Application Priority Data
Aug. 9, 2022 (DE) 10 2022 120 041.8

(51) Int. Cl. F16J 15/34; F16J 15/38

(52) U.S. Cl. CPC F16J 15/3472; F16J 15/38

(57) ABSTRACT

Mechanical seal arrangement comprising a mechanical seal (2) having a rotating slide ring (3) and a stationary slide ring (4), which define a sealing gap (5) between their sliding surfaces (3a), (4a), a holding component (6), (7) which is arranged on a rear side (3b), (4b) of one of the slide rings (3, 4), wherein the holding component (6), (7) comprises a main surface (60), (70) that faces the rear side (3b), (4b) of the slide ring (2), (4), wherein the main surface (60), (70) comprises a protruding rib (10) in the axial direction of the mechanical seal, a first annular groove (8), and a second annular groove (9), wherein the first annular groove (8), the second annular groove (9) and the annular rib (10) are arranged concentrically to one another, and the annular rib (10) protrudes beyond the main surface (60), (70) of the holding component (6), (7) by a length s, wherein the annular rib (10) is in contact with the rear side (3b), (4b) of the slide ring (3), (4), in order to provide a support on the rear side of the slide ring, wherein the annular rib (10) is arranged between the first annular groove (8) and the second annular groove (9), and wherein the first annular groove (8) and the second annular groove (9) are arranged directly adjacently to the annular rib.

The present invention relates to a mechanical seal arrangement having improved support functions and sealing functions on a rear side of a slide ring, and a reduction in transmission of disturbing forces to the slide ring, which leads to a reduced leakage at the sealing gap of the mechanical seal.

Mechanical seal arrangements are known in various configurations from the prior art. In cases of use in particular with toxic media, it is necessary to ensure that the mechanical seal arrangement is as leak-free as possible, both during operation, i.e. when the slide ring is rotating, and when the machine to be sealed is at a standstill. This of course also applies in other cases of use.

The object of the present invention is that of providing a mechanical seal arrangement which has minimal or no leaks in all types of operation, and which is as simple and cost-effective as possible to produce.

This object is achieved by a mechanical seal arrangement having the features of claim 1. Preferred developments of the invention are specified in the dependent claims.

The mechanical seal arrangement according to the invention, having the features of claim 1, has the advantage, compared with this, that a significant improvement is achieved with respect to leakage of the mechanical seal, and improved leak stability. This is particularly advantageous since this improvement is achieved with a surprisingly simple adjustment of a holding component, which is arranged on the rear side of one of the slide rings, wherein a significant leak reduction and improvement of the leak stability can be achieved. This is achieved according to the invention in that the mechanical seal arrangement comprises a mechanical seal having a rotating and a stationary slide ring, wherein the slide rings define a sealing gap between their sliding surfaces. The mechanical seal arrangement further comprises a holding component which is arranged on a rear side of one of the slide rings. The holding component comprises a main surface that faces the rear side of the slide ring. The holding component is for example a slide ring carrier which holds the slide ring. The main surface of the holding component comprises an annular rib that protrudes from the main surface in the axial direction of the mechanical seal, and a first and a second annular groove formed in the main surface. The two annular grooves and the annular rib are arranged concentrically to one another. In this case, the annular rib protrudes beyond the main surface of the holding component by a predetermined projection s. In this case, a measure for the protrusion of the annular rib beyond the main surface, which is perpendicular to a central axis of the mechanical seal, is relatively small and in particular less than 1 mm. In the mounted state, the annular rib is in contact with the rear side of the slide ring, in order to provide a support on the rear side of the slide ring. In this case, the annular rib is arranged between the first and the second annular groove. In this case, the first and second annular groove are arranged directly adjacently to the annular rib.

Thus, the skillful configuration, according to the invention, of the mechanical seal arrangement makes it possible to for a significantly improved sealing performance to be achieved by the mechanical seal arrangement. In this case, the annular rib allows for flexibilization of a contact between the holding component and the rear side of the slide ring. As a result, in particular disturbing forces, which can occur during operation of the slide ring on account of temperature changes, in particular temperature changes to high temperatures, and speed and pressure changes, can be compensated, without an evenness on the sliding surface of the slide ring being negatively influenced thereby. In this case, the invention can be used particularly advantageously in the case of mechanical seals in which the slide ring and the holding component are produced from different materials. In this case, the annular rib can be adjusted, with respect to its flexibility, to the materials and/or to the maximum and minimum temperatures to be expected, and temperature gradients to be expected accordingly, which is easily possible by means of the invention by way of a geometric shaping of the annular rib.

In this case, the holding component comprising the two annular grooves and the annular rib can be provided both on the rotating slide ring and/or on the stationary slide ring.

In this case, a mechanical weakening of the holding component is prevented by the selection of the geometric dimensions of the annular rib and of the two annular grooves.

Further preferably, a depth a′, a of the first and second annular groove is the same, or the depth a′ of the first annular groove is smaller than the depth a of the second annular groove. In the case of an identical depth, it is possible to ensure that geometrically identical conditions are present on both sides of the annular rib. This also simplifies and makes very cost-effective the producibility of the annular grooves and of the annular rib.

Further preferably, a width t′ of the first annular groove, extending in the radial direction, is identical to or different from a width t of the second annular groove, extending in the radial direction. In particular, the groove widths of the first and second annular groove are different. This has the advantage that the annular grooves, in addition to defining the annular rib, can also assume further functions. In this case, further preferably a secondary sealing element, in particular an O-ring or the like, is arranged in one of the annular grooves. Thus, a groove width of the two annular grooves is selected to be relatively large. In this case, the other groove width can be selected to be relatively small, since this is then merely introduced into the main surface of the holding component for producing the annular rib.

The holding component is particularly preferably a slide ring carrier which overlaps the slide ring. If the slide ring is the rotating slide ring, a torque introduction into the slide ring preferably also takes place via the holding component.

Further preferably, the holding component comprises an annular region which extends radially inside the slide ring. Consequently, the annular region forms a type of inner sleeve of the holding component, which can for example be arranged directly on a shaft or a sleeve, if the slide ring is the rotating slide ring. Preferably a third annular groove is arranged in this additional annular region, in third annular groove an additional secondary sealing element or a centering aid for the slide ring can be arranged.

Further preferably, the holding component comprising the annular rib is produced from a metal. In this case, the slide ring, on which the holding component is arranged, can also be produced from a metal material or alternatively from a ceramic, in particular SiC or WC.

Preferably a projection s of the annular rib beyond the main surface, which is perpendicular to the central axis of the mechanical seal, is in a range of 0.1 mm≤s≤0.5 mm. The projection is further preferably 0.2 mm.

Preferably, a free rib length l of the annular rib, proceeding from the annular groove of smaller depth, is in a range of 0.5 mm≤1≤6 mm. The rib length l is further preferably 1 mm≤1≤2 mm and is made up of the depth of the first annular groove a′ and the projection s.

Further preferably, a depth a′, a of the annular grooves, proceeding from the main surface of the holding component, is in a range of 0.2 mm≤a′≤6.5 mm and 0.2 mm≤a≤6.5 mm. The depth a′ is particularly preferably 2 mm.

Further preferably, a radial width t, t′ of the annular grooves is in a range of 0.1 mm to 7 mm. If no secondary sealing element or the like has to be arranged in an annular groove, a width of the annular groove is to be kept as small as possible, preferably in a range of 0.1 mm to 2 mm.

According to a further preferred embodiment of the invention, a thickness h of the annular rib is in a range of 0.2 mm≤h≤1 mm. The thickness h is particularly preferably 0.4 mm.

A ratio of the depth a′, a of the first and second annular groove (8, 9) to a thickness h of the annular rib 10 is preferably in a range of 0.2≤a′/h≤15 and 0.2≤a/h≤15.

Further preferably, a ratio of the maximum free rib length l of the annular rib to a thickness h of the annular rib is in a range of 0.5≤l/h≤15. This ensures that the annular rib on the one hand has sufficient flexibility, and on the other hand has sufficient mechanical rigidity.

A preferred embodiment of the invention will be described in detail in the following, with reference to the accompanying drawings, in which:

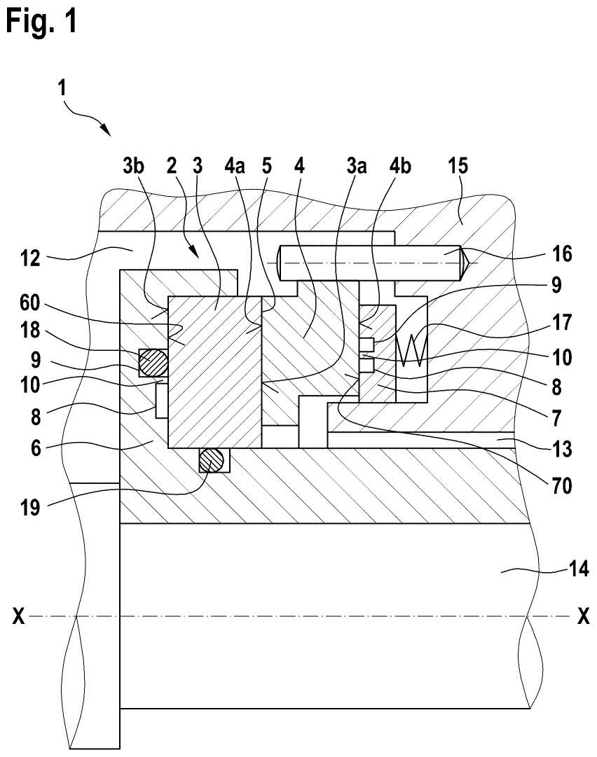

FIG. 1 is a schematic sectional view of a mechanical seal arrangement according to a first embodiment of the invention,

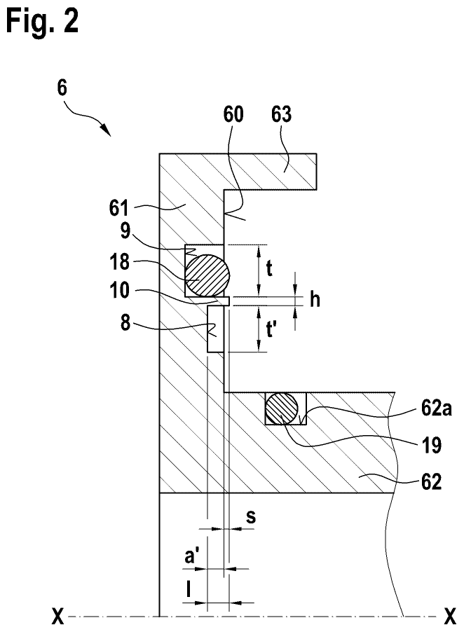

FIG. 2 is a schematic sectional view of a holding component of the mechanical seal arrangement from FIG. 1,

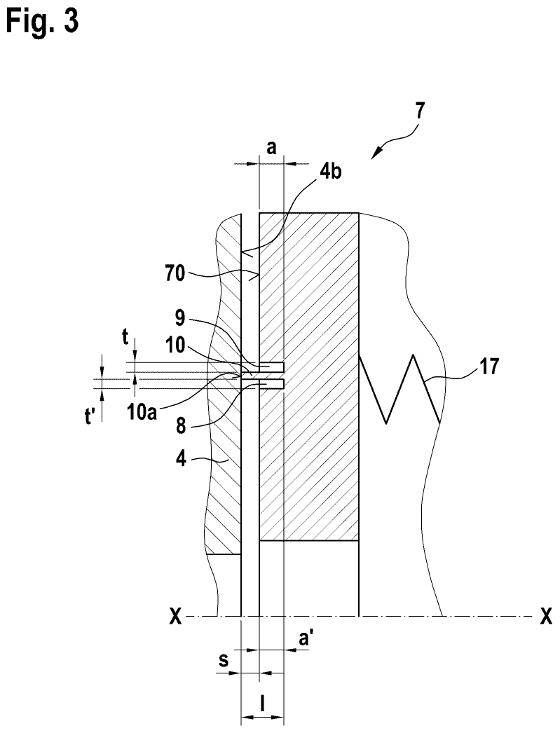

FIG. 3 is a schematic sectional view of a further holding component of the mechanical seal arrangement from FIG. 1,

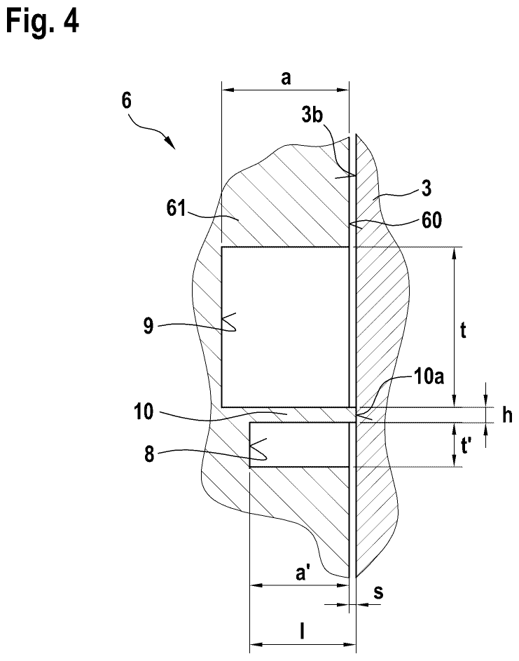

FIG. 4 is a schematic, enlarged partial sectional view of the holding component from FIG. 2, and

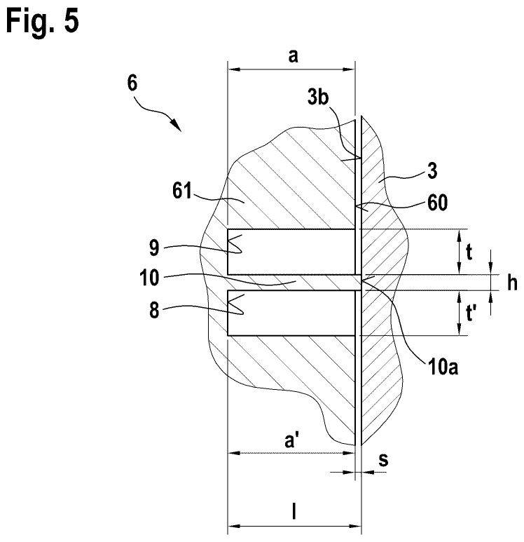

FIG. 5 is a schematic partial sectional view of an alternative embodiment of a holding component for a mechanical seal arrangement.

A mechanical seal arrangement 1 according to a preferred embodiment of the invention will be described in detail in the following, with reference to FIG. 1 to 4.

The mechanical seal arrangement 1 comprises, as shown in FIG. 1, a mechanical seal 2 having a rotating slide ring 3 and a stationary slide ring 4. A sealing gap 5 is defined between a sliding surface 3a of the rotating slide ring 3 and a sliding surface 4a of the stationary slide ring 4.

The mechanical seal 2 seals a product space 12 from an atmosphere 13 at a shaft 14. X-X denotes a central axis of the mechanical seal arrangement.

The rotating slide ring 3 is arranged on a first holding component 6. The first holding component 6 allows for torque transmission from the shaft 14 to the rotating slide ring 3. The first holding component 6 is shown in detail in FIG. 2.

The stationary slide ring 4 is arranged on a housing 15. In this case, the stationary slide ring 4 is preloaded in the axial direction of the mechanical seal by means of a preload element 17. A pin 16 serves for torque introduction and ensures the axial mobility relative to the housing 15.

A second holding component 7 is arranged on a rear side 4b of the stationary slide ring 4 and also visible in detail from FIG. 3.

The first holding component 6 which holds the rotating slide ring 3 in particular comprises an annular region 62, a radial region 61 and an overlap region 63. A side of the first holding component facing a rear side 3b of the rotating slide ring 3 forms a main surface 60 of the first holding component 6. The main surface 60 is arranged perpendicularly to the central axis X-X (cf. FIG. 2).

An annular rib 10, protruding in the axial direction of the mechanical seal, a first annular groove 8, and a second annular groove 9, are arranged on the main surface 60, which faces towards the rear side 3b of the rotating slide ring. As can be seen in particular from FIG. 2, in this case the annular rib 10 is arranged between the first annular groove 8 and the second annular groove 9. In this case, the two annular grooves 8, 9 and the annular rib are provided concentrically to one another.

As can furthermore be seen from FIG. 2, the annular rib 10 protrudes beyond the main surface 60 of the first holding component 6, in the axial direction X-X, by a projection s. As can be seen from the detail from FIG. 4, in this case the projection s is very small and is preferably in a range of 0.1 mm to 0.5 mm.

The first and second annular groove 8, 9 are thus arranged directly adjacently to the annular rib 10. A mechanical rigidity of the annular rib 10 results depending on a depth a′, a of the first and second annular groove 8, 9 and a thickness h of the annular rib 10. In this embodiment, a depth a′ of the first annular groove 8 is smaller than a depth a of the second annular groove 9 (cf. FIG. 4). As a result, a free rib length l of the rib 10 is defined.

Furthermore, a width t′ of the first annular groove 8 is also smaller than a width t of the second annular groove 9. As a result, the second annular groove 9 is designed to receive a secondary sealing element 18. The first annular groove 8 is merely a recess, in order to form the annular rib 10 on the main surface 60 of the first holding component 6. Therefore, the width t′ of the first annular groove 8 is significantly smaller than the width t of the second annular groove 9.

Furthermore, a further annular groove 62a is formed in the annular region 62, in which annular groove a further secondary sealing element 19 is arranged. Alternatively, a centering element for the rotating slide ring 3 can also be arranged here (cf. FIG. 2).

Thus, in the axial direction between the first holding component 6 and the rotating slide ring 3 merely a contact surface results at an end region 10a of the annular rib and the rear side 3b of the rotating slide ring 3. This makes it possible that disturbing forces, which can occur between the components of the mechanical seal on account of relative movements that are caused in particular by pressure and/or speed and/or temperature changes, can be reduced. This ultimately results, surprisingly, in a significantly improved leak stability of the mechanical seal arrangement, in particular in the case of rising and falling temperatures or also in the case of changing temperature gradients. Thus, a robustness of the mechanical seal arrangement with respect to disturbing influences can be significantly increased.

The first holding component 6 is preferably made of metal. The rotating slide ring 3 can also be produced from metal or alternatively also from a ceramic material. The thickness h of the annular rib 10 is preferably at most as wide as a minimum width t′, t of one of the annular grooves 8, 9 in this embodiment t′.

In this case, providing the annular rib 10 on the main surface 60 of the first holding component 6 does not lead to mechanical weakening of the first holding component 6, since the depth a′ of the first annular groove 8 is smaller than the depth a of the second annular groove 9 (cf. FIG. 4). Thus, the flexibilization of contact of the rotating slide ring 3 with respect to the first holding component 6 by providing the annular rib 10 makes it possible to achieve significantly better leakage behavior of the entire mechanical seal.

In the first embodiment, the same arrangement is also formed on the rear side 4b of the stationary slide ring 4. This is shown schematically in FIG. 3. In this case, the second holding component 7 is arranged on the rear side 4b of the stationary slide ring 4. The second holding component 7, like the first holding component 6, comprises a first annular groove 8, a second annular groove 9, and an annular rib 10 arranged between the two annular grooves 8, 9. A main surface 70 of the second component 7 is arranged in the direction of the rear side 4b of the stationary slide ring 4. The two annular grooves 8, 9 and the annular rib are in turn formed concentrically on the main surface 70. In this embodiment, the two annular grooves 8, 9 are provided merely for defining the annular rib 10. That is to say that neither of the two annular grooves 8, 9 has to be relatively large in order to be able to receive a secondary sealing element or the like.

Thus, the inventive concept is configured in the first embodiment both on the first holding component 6 for the rotating slide ring 3 and on the second holding component 7 for the stationary slide ring 4. The rear sides of the two slide rings 3, 4 are thus merely supported on the end regions 10a of the annular ribs 10. As a result, it is possible to achieve a minimum leakage during operation in all operating situations of the mechanical seal arrangement.

FIG. 5 shows an alternative embodiment of the first annular groove 9 of the first holding component 6. Similarly to in the case of the second holding component 7, in FIG. 5 the annular rib 10 is formed e.g. by two recesses, which form the first annular groove 8 and the second annular groove 9. In this case, the first and second annular groove 8, 9 are identical in cross-section, merely arranged on different radii and define the annular rib 10 between them. In this case, a depth a′, a of the first and second annular groove 8, 9 is identical. A width t′, t of the annular grooves 8, 9 is also identical. As a result, cost-effective production of the two annular grooves 8, 9 using the same tool is possible.

In addition to the above written description of the invention, for the additional disclosure thereof reference is hereby explicitly made to the illustration of the invention in FIG. 1 to 5.

### LIST OF REFERENCE SIGNS

1 mechanical seal arrangement
2 mechanical seal
3 rotating slide ring
3a sliding surface
3b rear side
4 stationary slide ring
4a sliding surface
4b rear side
5 sealing gap
6 first holding component
7 second holding component
8 first annular groove
9 second annular groove
10 annular rib
10a end region
12 product space
13 atmosphere
14 shaft
15 housing
16 pin
17 preload means
18 secondary sealing element
19 secondary sealing element
60 main surface
61 radial region
62 annular region
62a further annular groove
63 overlap region
70 main surface
X-X central axis
a, a′ depth of the annular groove proceeding from the main surface
h thickness of the annular rib in the radial direction
l free rib length
S projection of the annular rib beyond the main surface
t, t′ width of the annular groove in the radial direction

1. Mechanical seal arrangement, comprising
a mechanical seal having a rotating slide ring and a stationary slide ring, which define a sealing gap between the sliding surfaces thereof,
a holding component which is arranged on a rear side of one of the slide rings,
wherein the holding component comprises a main surface that faces the rear side of the slide ring,
wherein the main surface comprises a rib protruding from the main surface in the axial direction of the mechanical seal, a first annular groove formed in the main surface, and a second annular groove formed in the main surface,
wherein the first annular groove the second annular groove and the annular rib are arranged concentrically to one another, and the annular rib protrudes beyond the main surface of the holding component by a projection s,
wherein the annular rib is in contact with the rear side of the slide ring in order to provide a support on the rear side of the slide ring,
wherein the annular rib is arranged between the first annular groove (8) and the second annular groove, and
wherein the first annular groove and the second annular groove are arranged directly adjacently to the annular rib.

2. Mechanical seal arrangement according to claim 1, wherein a depth a′ of the first annular groove is smaller than or equal to a depth a of the second annular groove, proceeding from the main surface 70) of the holding component.

3. Mechanical seal arrangement according to claim 1, wherein a width t′ of the first annular groove extending in the radial direction of the mechanical seal is smaller than or equal to a width t of the second annular groove.

4. Mechanical seal arrangement according to claim 1, further comprising a secondary sealing element which is arranged in one of the annular grooves.

5. Mechanical seal arrangement according to claim 1, wherein the holding component and the annular rib are produced from a metal material.

6. Mechanical seal arrangement according to claim 1, wherein the projection s of the annular rib is in a range of 0.1 mm≤s≤0.5 mm; and/or wherein the rib length l of the annular rib, proceeding from the first annular groove, is in a range of 0.5 mm≤1≤6 mm.

7. Mechanical seal arrangement according to claim 2, wherein the depth a′ of the first annular groove and the depth a′ of the second annular groove proceeding from the main surface is in a range of 0.2 mm≤a′≤6.5 mm and 0.2 mm≤a≤6.5 mm.

8. Mechanical seal arrangement according to claim 1, wherein a thickness h of the rib is in a range of 0.2 mm≤h≤1 mm.

9. Mechanical seal arrangement according to claim 1, wherein a ratio of the depth a′, a of the first and second annular groove to a thickness h of the annular rib is in a range of 0.2≤a′/h≤15 and 0.2≤a/h≤15.

10. Mechanical seal arrangement according to claim 1, wherein a ratio of a free rib length l of the annular rib to a thickness h of the annular rib is in a range of 0.5≤l/h≤15.
